(19) United States
(12) Patent Application Publication
(10) Pub. No.: US 2017/0041277 A1
(43) Pub. Date: Feb. 9, 2017

(54) METHOD FOR DISTRIBUTING A MESSAGE

(71) Applicant: SIEMENS AKTIENGESELLSCHAFT, Munchen (DE)

(72) Inventor: Manfred LANGEN, Munich (DE)

(73) Assignee: SIEMENS AKTIENGESELLSCHAFT, Munchen (DE)

(21) Appl. No.: 14/849,118

(22) Filed: Sep. 9, 2015

(30) Foreign Application Priority Data
Aug. 7, 2015 (EP) 15180190.9

(51) Int. Cl. H04L 12/58; G06F 17/27

(52) U.S. Cl. CPC H04L 51/32; G06F 17/2785

(57) ABSTRACT

A user of a terminal connected to a communication network sends a message to a previously unknown group of receiving users based on a relationship data model of objects linked to each other by semantic and/or a social relations. The message is associated with metadata objects, e.g., two or more tags for defining a technical field, location, management level, of desired recipients, associated with the message. Subsequently, a weighted metadata object is generated using a quantifier determining a weight of metadata object(s) to which the quantifier is assigned. The at least one weighted metadata object associated with the submitted message is then mapped to objects of the relationship data model which results in generating at least one group of potential receiving users. The message is distributed via the communication network to a group of receiving users which are a subset of, e.g., filtered from, the group of potential receiving users.

### CROSS REFERENCE TO RELATED APPLICATIONS

This application claims the benefit of European Patent Application No. 15180190 filed on Aug. 7, 2015 which is incorporated by reference herein in its entirety.

### TECHNICAL FIELD

The disclosure relates generally to a method for distribution of a message submitted by a user to a previously unknown group of receiving users.

### BACKGROUND

Currently known forums and bulletin boards provide an abundance of information on various topics and may be used by individuals to solicit and provide information on a variety of topics. Such forums include enterprise social networks which are often used within a company with the aim of organizing collaboration of employees, e.g. for finding information on a particular subject, identifying subject matter experts, etc.

In the field of enterprise social networks, message distribution is a crucial factor. A message, e.g. a query or a request sent to a dedicated distribution group of users has the drawback that many other potentially interested recipients are not included in the distribution group. On the other hand, users included in a particular distribution group may not be interested in the contents of the query and will drop the received message.

Even more critical, users which are basically interested in contents of messages distributed by a particular distribution group may lose their interest due to a high number of received queries over a period of time so that a potential relationship between a distributing user and members of the distribution group may deteriorate over time.

### SUMMARY

Currently employed methods of automatically distributing messages to a previously unknown or undefined group of recipients provide for a sophisticated analysis of the message by a semantic and/or social relationship data model. Hereby, contents of the message along with meta data assigned to the message are evaluated and related to interests of potential recipients using a semantic data model utilizing terms linked to each other by semantic relations. Further, possible social relations are determined to retrieve potential recipients by evaluating a social network model of users linked to each other by social relations.

Although these methods are capable for an automatic determination of a group of possibly recipients, these methods are limited with respect to their flexibility in that they do not provide a distributing user for the possibility to fine-tune properties or criteria of a recipient as requested by the distributing user.

Accordingly, there is a need in the art for distributing messages to a previously unknown group of receiving users offering a flexible adjustment of properties or criteria of a desired recipient by the distributing user.

Systems and methods in accordance with various embodiments provide for distributing messages to a previously unknown group of appropriate recipients whose properties can by defined in an adjustable manner.

In one embodiment a method for distributing a message submitted by a user using a terminal connected to a communication network to a previously unknown group of receiving users is disclosed. A relationship data model is provided which has objects linked to each other by semantic and/or a social relations. The message submitted by the user is associated with a plurality of meta data objects, e.g. two or more tags for defining a technical field, location, management level, of desired recipients, associated with the message. Subsequently, a weighted meta data object is generated by assigning a quantifier to at least one of the plurality of meta data objects, the quantifier determining a weight of the at least one of the plurality of meta data object to which the quantifier is assigned to. The at least one weighted meta data object associated with the submitted message is then mapped to objects of the relationship data model. This mapping results in generating at least one group of potential receiving users. The submitted message is finally distributed via the communication network to a group of receiving users. The receiving users are a subset of the group of potential receiving users, i.e. filtered from the at least one group of potential receiving users.

A group of receiving users is changed dynamically depending on semantic content of the message, depending on social relationships between the users and depending of a weight which can be imposed by the users to certain individually definable and adjustable meta data objects.

According to an embodiment, meta data objects are definable or pre-defined tags. The user submitting the message is able to weight certain tags with a higher quantifier with respect to other tags which are assigned to a lower quantifier. In a possible user interface, meta data objects can be provided by a pre-defined tag, e.g. [symbol] technical expertise [symbol] while other meta data objects are definable by a text entry, e.g. [symbol] micromechanics [symbol] . A user may wish to adjust possible recipients of a message in a manner that the specialists in micromechanics should have a higher attention in receiving a message than specialists in the field of Finite Element Analysis, although persons specialized in the latter field should be regarded as well, as long as they have a connection to micromechanics. Accordingly, the user submitting the message will increase a control element assigned to the tag [symbol] micromechanics [symbol] while decreasing a control element assigned to the tag [symbol] Finite Element Analysis [symbol] . By increasing the control element the quantifier assigned to this meta data object, or tag, is increased to a higher value, determining the weight of the hereby defined weighted meta data object.

In a possible embodiment the meta data or tag is derived automatically from the message submitted and subject to be altered or weighted by a quantifier using a control element assigned to the tag.

In a possible embodiment, the relationship data model provides a semantic network data model utilizing terms linked to each other by semantic relations and/or a social network data model of users linked to each other by social relations.

In a possible embodiment a mapping engine is adapted to expand the at least one term associated with the submitted message to related terms on the basis of weighted semantic relation links of the semantic network data model.

In a possible embodiment, a mapping engine is adapted to calculate a sorted list of associated related terms being associated with the at least term of the submitted message on the basis of weighted semantic relation links of the semantic network data model to identify users having a relation to the related associated terms.

In a possible embodiment the mapping engine is adapted to expand the identified users having a relation to the related associated terms by users having a close social relationship with the identified users on the basis of the weighted social relation links of the social network data model.

In a possible embodiment the mapping engine is adapted to derive a group of potential receiving users for the submitted message from the expanded group of identified users.

In a possible embodiment the distribution is adapted to derive the group of receiving users from the submitted message from the filtered sorted list of associated terms provided by the distribution filter.

In a possible embodiment the distributing of the submitted message includes assigning at least quantifier to a distribution filter delimiting the group of the receiving users filtered from the at least one group of potential receiving users, the distribution filter related to at least one of:
an expected expertise of receiving users;
a level of importance of the submitted message;
a priority of the submitted message; and/or;
a size of the group of receiving users and/or an expected number of submitted messages.

In an alternative embodiment the communication network comprises a wireless network.

In a possible embodiment the quantifier assigned to the distribution filter is assigned by the user submitting the message or calculated on the basis of importance criteria comprising a business impact, an urgency and a topic novelty of the submitted message.

In a possible embodiment the relationship data model includes at least one of a semantic data model, social network data model, and/or a multi-layered relationship model.

According to a possible embodiment a computer program product is disclosed, which contains a program code stored on a computer-readable medium and which, when executed on a server of a communication network, carries out one of the preceding methods.

### BRIEF DESCRIPTION OF THE DRAWINGS

These and other aspects and advantages will become more apparent and more readily appreciated from the following description of the exemplary embodiments, taken in conjunction with the accompanying drawing accompanying drawings of which:

FIG. 1 is a block diagram of a communication network according to an embodiment; and

FIG. 2 is simplified display image of a possible user interface according to an embodiment including tag fields and slider control elements for adjusting a quantifier.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

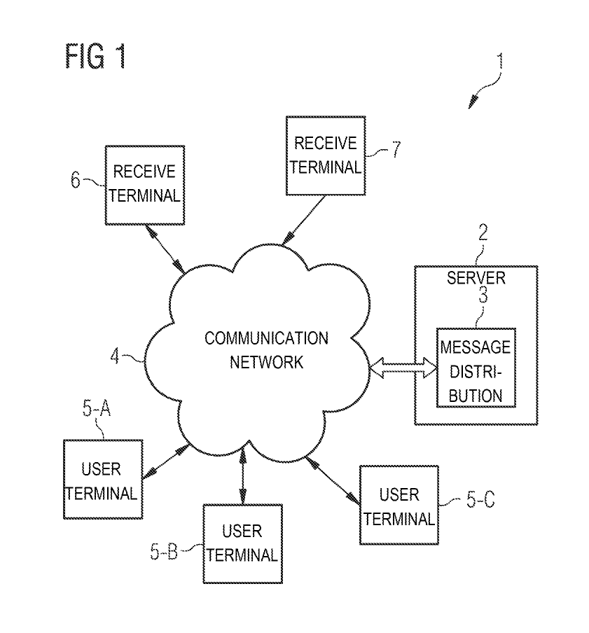

FIG. 1 shows a communication system 1 comprising at least one message distribution apparatus 3 assigned to a server 2 of the communication system 1. A—not shown—electronic message which is submitted by a user of a terminal 5-A is distributed by the message distribution apparatus 3.

The message distribution apparatus 3 is provided for distributing an electronic message submitted by the user of the terminal 5-A. Each terminal 5-A,5-B,5-C comprises a user interface for a corresponding user.

Users may include natural persons exchanging messages via the communication network 4 or higher layer applications using the message distribution system 1 for exchanging information.

The communication network 4 as shown in FIG. 1 can be any kind of network, in particular a wired or wireless network. The communication network 4 can comprise a data network including a local area network LAN, a wide area network WAN, the internet. The communication network 4 is adapted to transport electronic messages including e-mails, SMS messages, RSS-feeds, voice messages or any kind of data packet streams. The message distribution apparatus 3 comprises a—not shown—mapping engine and a—not shown—distribution engine.

The message distribution apparatus 3 is provided for distributing a message submitted by the user of terminal 5-A connected to the communication network 4 to a previously unknown group of receiving user terminals 6,7.

When distributing a message submitted by a user using a terminal connected to a communication network to a previously unknown group of receiving users, a relationship data model comprising is used. This data model includes objects linked to each other by semantic and/or a social relations.

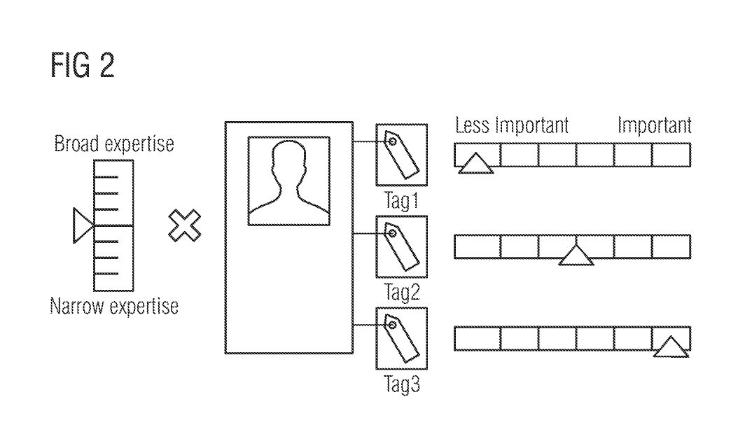

FIG. 2 shows a possible user interface for adjusting weights of meta data assigned to a message according to an embodiment. In a centre part of the figure an icon of the user submitting the message is shown which is neighboured by a list of meta data, here Tag 1, Tag 2, Tag 3. A control element, here a slider, is assigned to each of these tags. The control element is exemplarily adjusted to an adjusted quantifier of less importance for Tag 1, medium importance for Tag 2 and high importance for Tag 3. The message to be submitted is not shown in FIG. 2.

The quantifier is used to weight meta data objects according to the disclosed embodiments, which is effecting the choice and/or count of semantic or social relation algorithms according to a meta data object and its weight. A quantifier of meta data object or tag with the lowest weight is assigned a value of 1 whereas other higher adjusted quantifier have a value of >1.

Adjusting the sliders is affecting the weight of one weighted meta data in relation to another weighted meta data and in relation to the total weighted meta data.

The weighted meta data may be considered by two possible embodiments: According to a first embodiment, a higher weight of meta data is considered by semantically expanding the tag, i.e. by increasing synonyms and semantic terms related to the tag to which the quantifier is assigned to. Expanding the tag may further include terms having a semantic distance specified by the weight. This will increase the importance of the higher weighted tag in relation to other tags, whereas a tag with a quantifier of 1 is not expanded in this sense. Expanding the tag will further increase the number of recipients, since additional terms will naturally increase persons which are possibly interested topics of expanded tags. Further on, a higher weight may include terms which have a co-occurrence or co-tagging relation with the meta data to which the quantifier reflecting the weight is assigned to. Still further an influence is imposed by the fact that the user sending the message has used the meta data or tag herself or himself, or, if she or he rather belongs to a community which is associated by this tag.

According to a second embodiment, a higher weight of meta data is considered by directly influencing a ranking of search terms. By this variant, no further semantic resources are expanded, only the ranking of a group of potential receiving users is reorganized. Both embodiments are certainly combinable.

In addition to an adjustment of weighted meta data, another quantifier is used to adjust a quantifier to a distribution filter delimiting the group of the receiving users filtered from the at least one group of potential receiving users. The quantifier for the distribution filter is related to a desired expertise of a desired user group of recipients and adjusted by a slider. Alternatively, the quantifier may be related to a level of importance of the submitted message and/or a priority of the submitted message.

In an alternative embodiment, an adjustment of the quantifier leads to a different selection algorithms. The selection algorithm includes various selection criteria and does not necessarily lead to the same or a subset of the same group.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

The communication network may include permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

What is claimed is:

1. A method for distributing a message submitted by a user by a terminal connected to a communication network to a previously unknown group of receiving users, the method comprising:
providing a relationship data model of objects linked to each other by at least one of semantic relations and social relations;
providing meta data objects associated with the message submitted by the user;
generating a weighted meta data object by assigning a quantifier to at least one of the meta data objects, the quantifier determining a weight of the at least one of the meta data objects to which the quantifier is assigned;
mapping at least one weighted meta data object associated with the message to at least one of the objects of the relationship data model;
generating at least one group of potential receiving users as a result of said mapping; and
distributing the message via the communication network to a group of receiving users filtered from the at least one group of potential receiving users.

2. The method according to claim 1, wherein the relationship data model includes at least one of a semantic network data model utilizing terms linked to each other by semantic relations and a social network data model of users linked to each other by social relations.

3. The method according to claim 1, wherein the meta data objects associated with the message include a tag, the tag being at least one of assigned by the user submitting the message and derived from the message.

4. The method according to claim 1, wherein said mapping of the at least one weighted meta data object to the at least one of the objects of the relationship data model includes expanding the at least one weighted meta data object associated with the message to related associated terms based on weighted semantic relation links of the semantic network data model.

5. The method according to claim 4, wherein said mapping of the at least one weighted meta data object to the at least one of the objects of the relationship data model includes calculating a sorted list of associated related terms being associated with the at least one weighted meta data object of the submitted message based on weighted semantic relations of the relationship data model identifying users having a relation to the related associated terms.

6. The method according to claim 5, wherein said mapping of the at least one weighted meta data object to the at least one of the objects of the relationship data model includes expanding identified users having a relation to the associated related terms by including users having a close social relationship with the identified users based on the social relations of the relationship data model.

7. The method according to claim 1, wherein said distributing of the message via the communication network includes assigning at least one quantifier to a distribution filter delimiting the group of the receiving users filtered from the at least one group of potential receiving users, the distribution filter related to at least one of:
an expected expertise of receiving users;
a level of importance of the message;
a priority of the message;
a size of the group of receiving users; and
an expected number of submitted messages.

8. The method according to claim 7, wherein the at least one quantifier assigned to the distribution filter is at least one of assigned by the user submitting the message and calculated based on importance criteria, including at least one of a business impact, an urgency and a topic novelty of the message.

9. The method according to claim 1, wherein the relationship data model includes at least one of a semantic data model, a social network data model, and a multi-layered relationship model.

10. A non-transitory computer-readable medium embodying program code which, when executed on a server of a communication network, carries out a method comprising:
providing a relationship data model of objects linked to each other by at least one of semantic relations and social relations;
providing meta data objects associated with the message submitted by the user;
generating a weighted meta data object by assigning a quantifier to at least one of the meta data objects, the quantifier determining a weight of the at least one of the meta data objects to which the quantifier is assigned;
mapping at least one weighted meta data object associated with the message to at least one of the objects of the relationship data model;
generating at least one group of potential receiving users as a result of said mapping; and
distributing the message via the communication network to a group of receiving users filtered from the at least one group of potential receiving users.
